(19) United States
(12) Patent Application Publication
(10) Pub. No.: US 2006/0129919 A1
(43) Pub. Date: Jun. 15, 2006

(54) Disparate GIS file format management system and method

(76) Inventor: Kevin Edmundson, Indianapolis, IN (US)

Correspondence Address: BARNES & THORNBURG, LLP, P.O. BOX 2786, CHICAGO, IL, 60690-2786, US

(21) Appl. No.: 11/013,112

(22) Filed: Dec. 15, 2004

(51) Int. Cl. G06F 17/21; G06F 15/16

(52) U.S. Cl. 715/523; 709/217

(57) ABSTRACT

A system, method, and computer program module for managing the conversion and distribution of disparate file format GIS files. The method involves the steps of first uploading source files to a server. Next, the steps of determining a list of desired formats for each source file, converting each source file to each desired format, and sending the converted source files to other entities are performed. The files are copied to each entity's system or server so each entity has constant access to the data contained in each other entity's source files.

### BACKGROUND AND SUMMARY

The present disclosure relates to a system, method, and computer program module for managing Geographic Information Systems files known as “GIS” files among various entities having incompatible GIS file systems. GIS files store imagery and other information about a specific geographic region. GIS files are used in connection with monitoring software used by a variety of government, industry, and not-for-profit entities for many services including, but not limited to surveying, disaster response, and other services. GIS information may also be used within county government and private industry for cadastral information management such as taxing information, zoning, road right-of-way, public safety response management, voter registration, and infrastructure planning.

Certain entities that use GIS files may have an interest in using the GIS files created or maintained by other entities, such as entities in neighboring geographic regions like neighboring counties, states, or other regions. A problem faced by such entities is that not all GIS creation, manipulation, and viewing systems (hereafter “GIS viewers”) are compatible. Often, GIS users are government entities or other resource-poor entities that do not have the resources to obtain multiple GIS viewers, or do not have the time or budgeted human resources to convert other entity's files into a native format compatible with its GIS viewer.

Another problem is the need of many entities to have some version of the information contained in the GIS files available at all times. The need for constant access may be even more important than the need for access to updated information because the geographic, large utility system information, or other generally static information does not change very often. This need, for example, may arise in fire or crime response systems which need constant access to map information, even if that information is somewhat outdated. A unique need therefore exists in the GIS context for the information to be stored locally in each entity's system or server in case communications networks are damaged, disrupted, or otherwise unavailable. This is a difference from existing systems that provide file access or file conversion remotely through a web portal or the like. Such systems would be unsuitable to many GIS users because of the possibility of an Internet outage, denial of service attack, or other disruption that may leave such users without the vital access they need.

Briefly, in accordance with the foregoing, disclosed is a system, method and computer program product for managing the conversion and distribution of disparate file format GIS files in a community of entities having incompatible GIS file systems. Each entity in the community of entities is able to upload files to a server or general purpose computer. The uploaded GIS files are converted to the file format of other entities' systems to create a pool of interpreted files. Each entity is able to establish a connection and retrieve the GIS files of other entities in the GIS file's original format if compatible, or in interpreted file format if incompatible. Files retrieved from the pool are stored locally on each entity's system. The system may also include authentication, security, source and other accountability tracking to know which entity, or which particular person at each entity, created, uploaded or modified the file, to help ensure the accuracy and accountability of the data contained therein.

Additional features will become apparent to those skilled in the art upon consideration of the following detailed description of drawings exemplifying the best mode as presently perceived.

### BRIEF DESCRIPTION OF THE DRAWINGS

The present disclosure will be described hereafter with reference to the attached drawings, which are given as a non-limiting example only, in which:

FIG. 1 is a flowchart showing the steps in a method for managing the conversion and distribution of disparate file format GIS files in a community of entities having incompatible GIS file systems;

FIG. 2 is a simplified diagrammatic view of a community of entities having incompatible GIS file systems;

FIG. 3 is a simplified diagrammatic view of the community of entities of FIG. 1 sending source files to a group source module and file storage and management module;

FIG. 4 is a simplified diagrammatic view identifying source files and interrupted files en route to the storage and management module and through a file conversion module;

FIG. 5 is a simplified diagrammatic view showing the source and interrupted files being retrieved by a member entity from the storage and management module; and

FIG. 6 is a diagrammatic view of a system for managing the conversion and distribution of disparate file format GIS files in a community of entities having incompatible GIS file systems.

### DETAILED DESCRIPTION

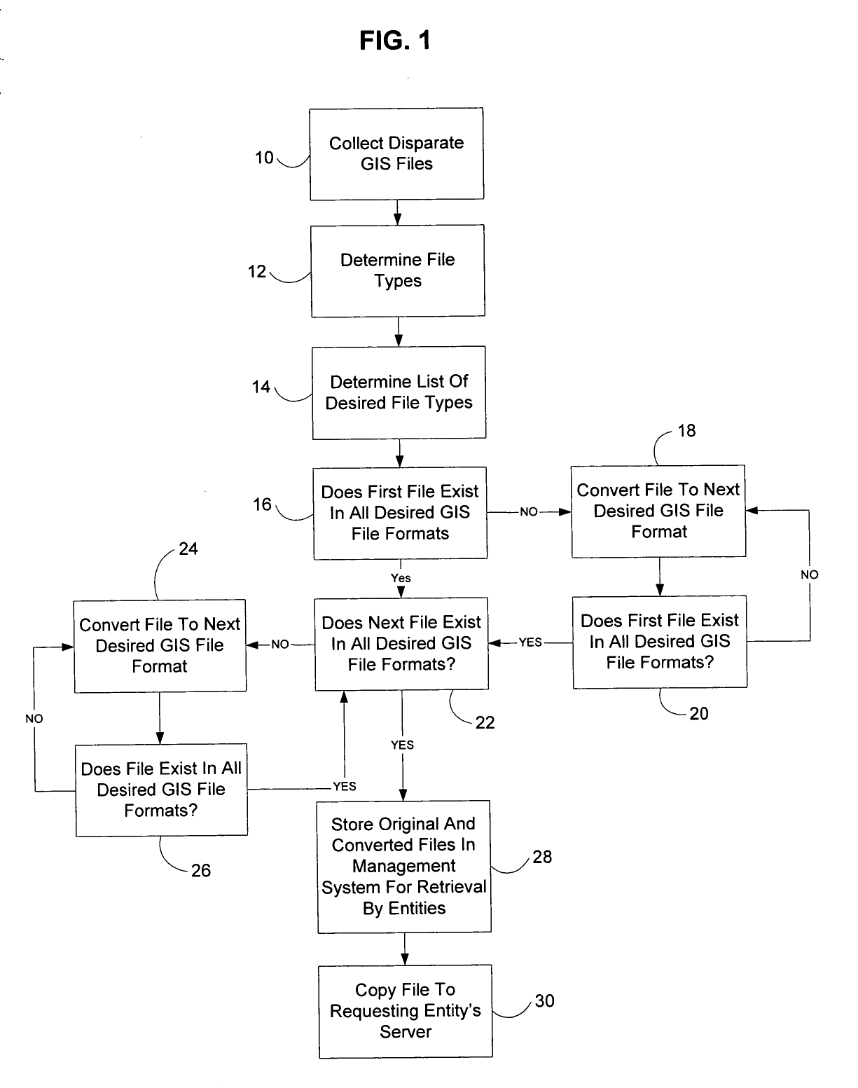

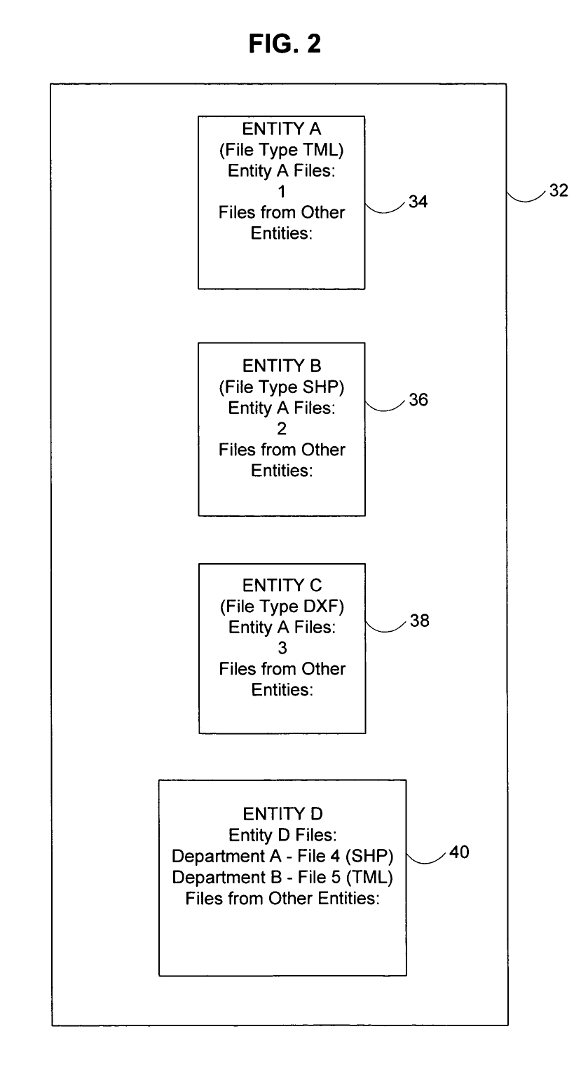

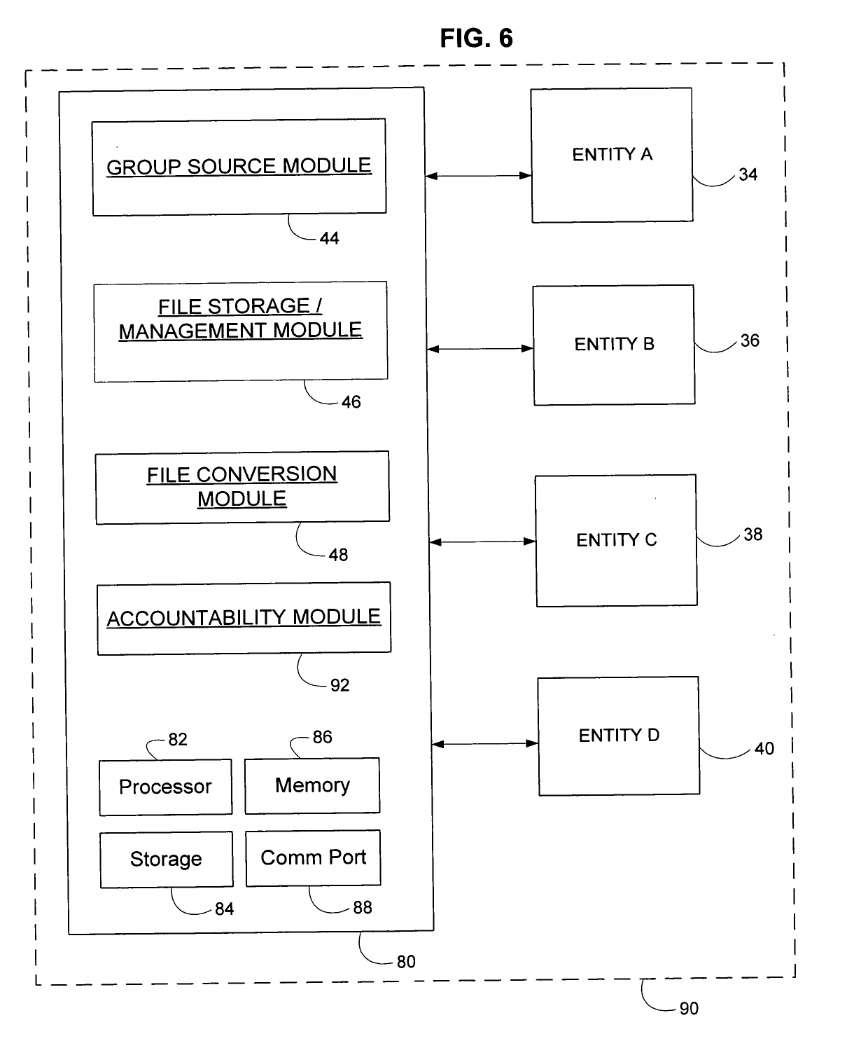

FIG. 1 shows the general steps involved in managing the conversion and distribution of disparate file format GIS files in a community of entities having incompatible GIS file systems. It is understood that two or more entities in the community would have incompatible GIS file system, but that some entities in the community may have compatible GIS file systems. FIG. 2 depicts such a community 32, which has four entities for purposes of illustration and not limitation, entity A 34, entity B 36, entity C 38, and entity D 40. An entity may be any user of GIS files, including by way of example, but not limitation, government entities at any level including, city, county, state, or federal levels, service providers, commercial entities, not-for-profits, educational institutions, and individuals. The entities may be cross-jurisdictional such as voter registration groups working with governmental groups or inter-jurisdictional such as several different, but related groups in the same governmental level or entities such as Homeland Security. In a first step 10, disparate GIS format files are retrieved from or sent by one or more entities 34, 36, 38, 40 to a general purpose computer or server 80, such as one shown in FIG. 6. A GIS file format can be any file format used or manipulated by any GIS viewer, including, for purposes of illustration but not limitation, file types with the following extensions: .SHP, .DXF, .CAD, .TML, .MID, and .MIF. These file types generally correspond to currently available commercial viewers used in the industry including ProViewer from MapInfo, ArcGIS from Environmental Systems Research Institute, Inc., Think Map from WTH Engineering, Inc., and AutoCad from Autodesk, Inc. These GIS viewers and associated companies are mentioned for illustrative purposes. The present system, method, and computer program product or module may be used by entities using any combination of any of the GIS file types or other GIS files with any of these, or other GIS viewers. The choice and type of files is to be broadly interpreted to include file types not mentioned herein and yet to be conceived. Each entity may have a GIS viewer capable of reading numerous formats, but may generally have a preferred or native format that its viewer most easily creates, modifies, manipulates, or otherwise allows use of its GIS files. The native file types of each entity is determined in a next step 12.

In a next step 14, a list is created that compiles the desired GIS file types for each entity. For example, if four entities, each with a different compatible GIS file type, want each other entity's GIS files, each source file would need to be converted to the three other formats used by the other entities. The list of desired formats may be used to develop an action plan or conversion routine to lay out to which GIS formats each of the source files will need to be converted.

Steps 16-26 generally describe the steps involved in the first source file and each subsequent source file being converted to an interpreted file in each other entity's desired GIS format. First, a determination is made about whether the first file exits in all desired file formats (step 16). If not, the file is converted to one desired GIS file format (step 18). Loop 18-20 continues until the first file has been converted to all desired GIS file formats. Similarly, loop 22-24-26 is performed until all subsequent uploaded files have been converted to all desired formats. In this manner, a pool of files containing all the source files, and all converted or interpreted files are stored in a management system accessible by the participating entities (step 28). The source and interpreted files in the requesting entity's native format are then copied to the requesting entity's system or server (step 30).

FIG. 2 illustrates an example of four entities having incompatible GIS file systems. Entity A 34 in this example has GIS source file 1 in TML format. At the stage shown in FIG. 2, entity A has no files from any other entity. Similarly, entity B 36 has file 2 in SHP format and entity C 38 has file 3 in DXF format. Entity D 40 has two departments, A and B, each using GIS files in incompatible formats. File 4 is in SHP format for department A, and file 5 is in TML format for department B. It is not uncommon for different departments or other subunits within an entity to use different, incompatible GIS viewers. Thus, there may be a need for the present system to be used among subunits of a particular entity as well.

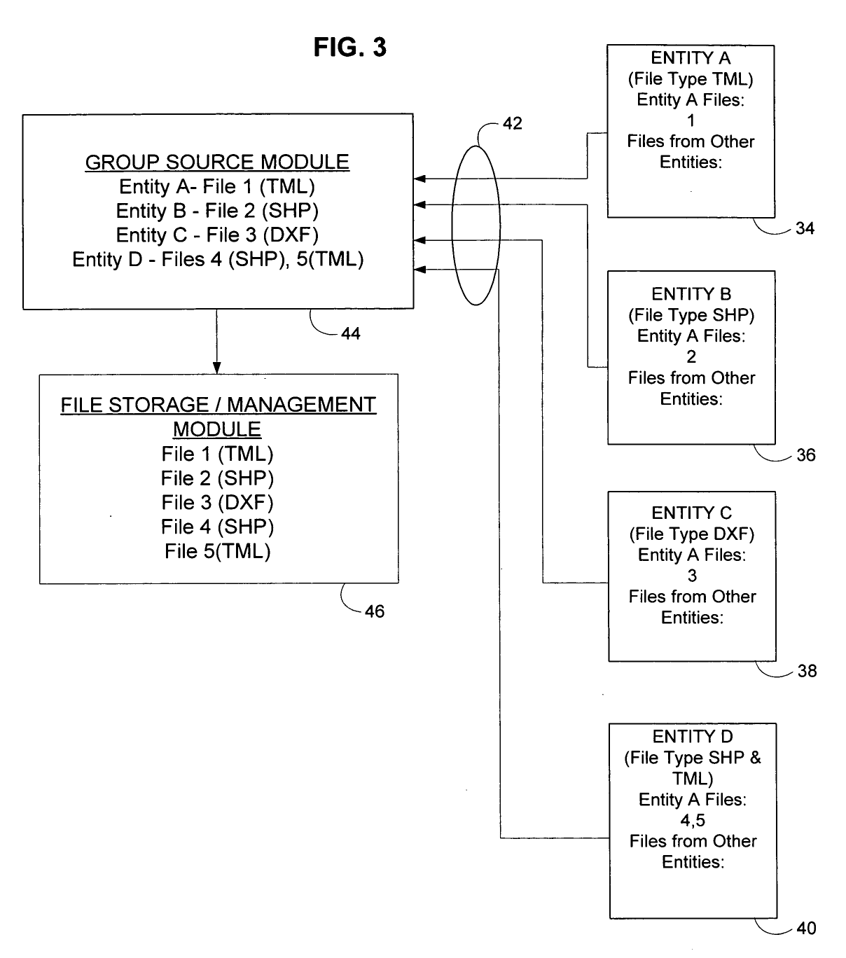

As shown in FIG. 3, each of the entities, 34, 36, 38, 40 uploads its source files over a communications network or connection 42 to a group source module 44. Communications network or connection 42 may be a publicly available communications network such as the Internet, a proprietary network, a dial-in connection, a wired or wireless connection, or any other suitable communications path currently available or yet to be conceived. Group source module 44 identifies the file type of each uploaded GIS file and its source. A file storage and management module 46 stores the uploaded files. The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like as well as those yet to be conceived.

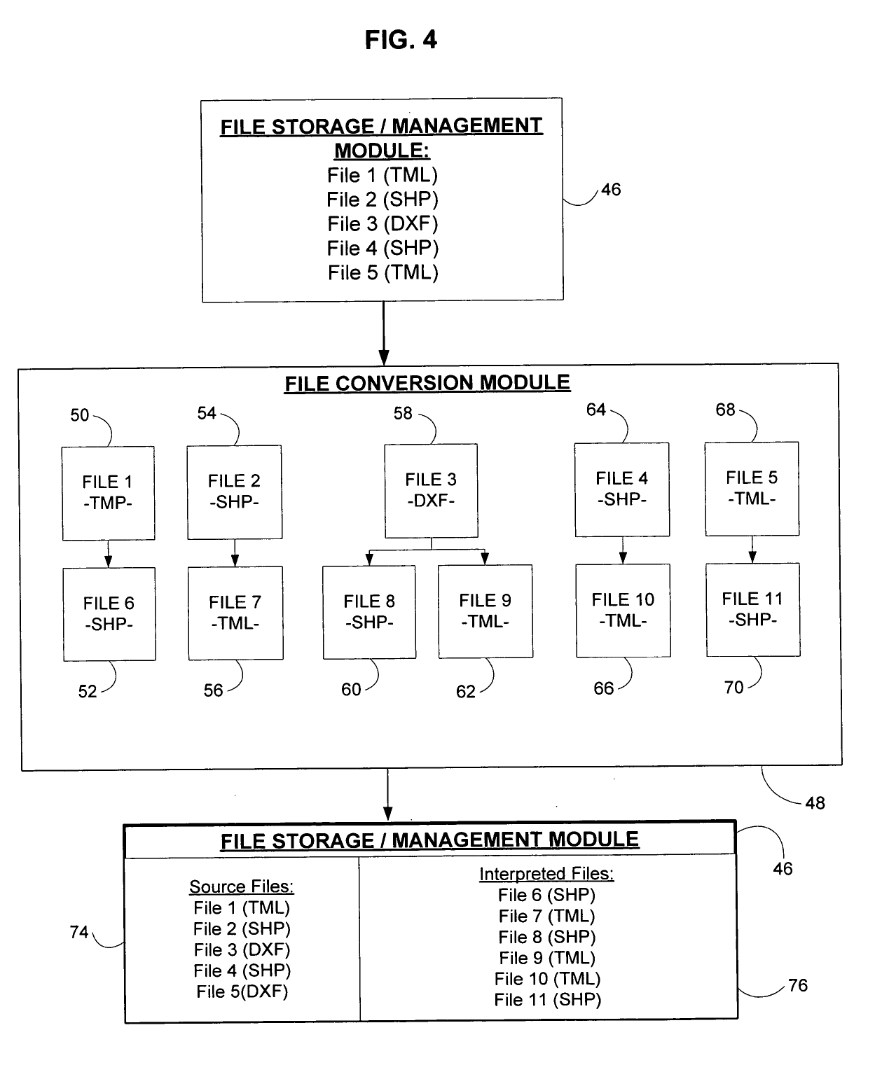

FIG. 4 is a simplified diagrammatic view identifying a file conversion of the present method. Source files are sent from file storage module 46 to a file conversion module 48. Assuming entity A's system cannot read SHP files, and entity B's system cannot read TML files, but that Entity C can read both SHP and TML files, the following conversions would be needed. Source TML file “1” 50 would be converted to interpreted SHP file “6” 52. Source SHP file “2” 54 would be converted to interpreted TML file “7” 56. Source DXF file “3” 58 would be converted to interpreted SHP file “8” 60 and interpreted TML file “9” 62. Source SHP file “4” 64 would be converted to interpreted TML file “10” 66. Finally, source TML file “5” 68 would be converted to interpreted SHP file “11” 70. Any known conversion technique or conversion module may be used to perform these conversions, including the conversion algorithms that may be employed by the above-mentioned commercially available GIS viewers to save or load GIS files in more than one format. The interpreted files 76 are added to the source files 74 on the file storage module 46.

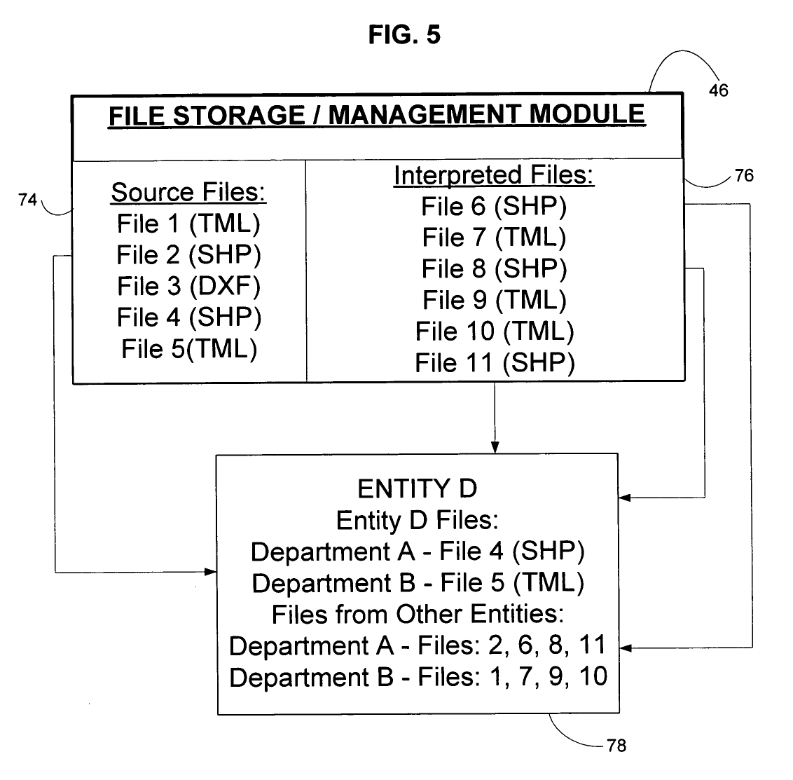

Each entity would then login or otherwise establish a connection to module 46 to retrieve files from each of the other entities. FIG. 5 shows the retrieval of files by entity D 78. Department A of entity D 78 would retrieve source file 2 and interpreted files 6, 8, and 11. Department B of Entity D 78 would retrieve source file 1 and interpreted files 7, 9, and 10. In this manner, both departments have all the GIS files of all other entities and departments in each retrieving department's native GIS file format. The files would be stored locally on entity D's server or GIS management system.

Updating can be performed spontaneously or at the discretion of the user or according to any schedule, including daily, weekly, monthly, quarterly, yearly, at any multiple of any of these schedules, or according to any other schedule. The need for the information to be up-to-date depends on the intended use of the data. For example, in a situation where public safety is concerned such as use by a 911 dispatch center, it may be necessary for the information to be updated on a daily basis or even more frequently. Important addressing information may be critical to efficient response. However, in a situation such as where a government agency uses GIS information for conducting voter registration, an update quarterly may be sufficient.

FIG. 6 is a diagrammatic view of a system for managing file conversion and distribution of disparate format GIS files. The system 80 includes group source module 44, file storage and management module 46, and file conversion module 48, the operative instructions of which have been described above. These modules are interpreted by a processor 82 programmed to operate system 80 and its storage 84, memory 86, and communications port 88 accordingly. A larger system 90 may also be said to encompass one or more entities 34, 36, 38, 40 and system 80.

System 80 may also include an accountability module 92 that contains instructions or programming interpretable by the processor to track source information about each uploaded GIS file. This may be important to GIS file users because, for purposes of illustration and not limitation, the accuracy of the information may be vital to perform civil services such as flood or fire response. The author or last modifier of any source file and its resultant interpreted files may be monitored by the accountability module 92 using any standard method such as, by way of example, but not limitation, digital signature, watermarking, or metadata. An ownership parameter may be attributed to each file for such accountability monitoring purposes.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the disclosure are desired to be protected. The applicants have provided description and figures which are intended as illustrations of embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

What is claimed is:

1. A method for managing the conversion and distribution of disparate file format GIS files in a community of entities having incompatible GIS file systems, the method comprising the steps of:
(a) for each entity in the community of entities, identifying a compatible GIS file format;
(b) allowing one or more of the entities in the community of entities to upload selected GIS files that are in the native GIS format of the one or more entities to a general purpose computing device, the general purpose computing device comprising a conversion program module;
(c) running the conversion program module to convert each uploaded selected GIS file to one or more interpreted files that are in a native GIS format of each other entity in the community of entities; and
(d) sending to each entity one or more of the uploaded selected GIS files or interpreted files such that each entity has the GIS files of all the other entities in the community of entities in a compatible GIS format.

2. The method of claim 1, further comprising attributing an ownership parameter to each uploaded selected GIS file.

3. The method of claim 2, further comprising tracking the ownership parameter of each individual uploaded GIS file and each interpreted file that is converted from each individual uploaded GIS file.

4. The method of claim 1, further comprising the steps of:
(e) allowing one or more of the entities in the community of entities to upload updated selected GIS files;
(f) tracking revision information about the updated selected GIS files; and
(g) performing conversion step and sending step on the updated selected GIS files.

5. The method of claim 1, further comprising the tracking revision information including information about a last user that modified the selected GIS file.

6. The method of claim 1, the disparate file formats for the GIS files being selected from a group comprising of files having an extension: .shp, .dxf, and .tml.

7. A method for managing the conversion and distribution of disparate file format GIS files in a community of entities having incompatible GIS file systems, the method comprising the steps of:
(a) allowing one or more of the entities in the community of entities to upload selected GIS files that are in the native GIS format of the one or more entities over a communication path to a general purpose computing device;
(b) determining the file format of each of the uploaded selected GIS files;
(c) developing a list of desired GIS file formats based on the determination in step b.
(d) iteratively converting each of the uploaded selected GIS files to each of the formats on the list to create a plurality of interpreted files;
(e) allowing each entity to act as a requesting entity that remotely connects to the general purpose computer to request the source files and interpreted files from each of the other entities in the community of entities that are in the native format of the requesting entity; and
(f) in response to authenticating the requesting entity, transmitting to the requesting entity the source files and interpreted files from each of the other entities in the community of entities that are in the native format of the requesting entity.

8. The method of claim 7 further comprising each entity having a local GIS file management system.

9. The method of claim 8, further comprising each entity storing the source files and interpreted files on the file management system of each entity.

10. The method of claim 7, further comprising the communications path being a dial-in connection.

11. A system for managing the conversion and distribution of disparate file format GIS files serving a community of entities having incompatible GIS file systems, the system comprising:
a general purpose computing device, the general purpose computing device having a computer program comprising:
a group source module, the group source module containing instructions interpretable by the processor to receive uploaded GIS files, identify a file format for each uploaded GIS file, and identify the source of each uploaded GIS file;
a file storage management module, the file storage management module containing instructions interpretable by the processor to store and manage the uploaded GIS files; and
a file conversion module, the file conversion module containing instructions interpretable by the processor to convert an uploaded GIS file to one or more interpreted files, the interpreted files having a GIS file format different than that of the uploaded GIS file.

12. The system of claim 11, further comprising an action list module, the action list module containing instructions interpretable by the processor to analyze the file formats of the uploaded GIS files to develop a desired file formats list.

13. The system of claim 12, further comprising the file conversion module further containing instructions interpretable by the processor to query the desired file formats list and create an interpreted file for each uploaded GIS file in every GIS file format on the desired file formats list.

14. The system of claim 11, further comprising an accountability module, the accountability module containing instructions interpretable by the processor to track source information about each uploaded GIS file.

15. A computer readable medium for managing the conversion and distribution of disparate file format GIS files serving a community of entities having incompatible GIS file systems, the computer readable medium bearing instructions for performing the following steps:
(a) for each entity in the community of entities, identifying a compatible GIS file format;
(b) allowing one or more of the entities in the community of entities to upload selected GIS files that are in the native GIS format of the one or more entities to a general purpose computing device, the general purpose computing device comprising a conversion program module;
(c) running the conversion program module to convert each uploaded selected GIS file to one or more interpreted files that are in a native GIS format of each other entity in the community of entities; and
(d) sending to each entity one or more of the uploaded selected GIS files or interpreted files such that each entity has the GIS files of all the other entities in the community of entities in a compatible GIS format.
